(19) United States
(12) Patent Application Publication
(10) Pub. No.: US 2003/0136381 A1
(43) Pub. Date: Jul. 24, 2003

(54) Fuel injector

(76) Inventors: Guenter Dantes, Eberdingen (DE); Detlef Nowak, Untergruppenbach (DE)

Correspondence Address: KENYON & KENYON, ONE BROADWAY, NEW YORK, NY, 10004, US

(21) Appl. No.: 10/203,601

(22) PCT Filed: Dec. 11, 2001
(86) PCT No.: PCT/DE01/04627

(30) Foreign Application Priority Data
Dec. 11, 2000 (DE) 100 61 571.6

(51) Int. Cl. F02M 61/10

(52) U.S. Cl. 123/445

(57) ABSTRACT

A fuel injector for fuel injection systems of internal combustion engines includes a valve-seat member (5), in which a valve-seat surface (6) is introduced, which cooperates with a valve-closure member (4), mechanically linked to a valve needle (3), to form a sealing seat, and at least one spray-discharge orifice (7); in the idle state of the fuel injector (1) a gap (31), whose length (1) is smaller than the opening lift of the fuel injector (1), is situated between a downstream part of valve needle (3) and a recess (33) introduced in valve-seat member (5) on its upstream side.

### BACKGROUND INFORMATION

The present invention is based on a fuel injector according to the preamble of the main claim.

Fuel injectors, which are opened by using a valve-closure member which lifts up inwardly from a valve-seat surface, are known. German Patent Application 197 36 682 A1 describes a fuel injector where the valve-closure member and the valve needle are designed in one piece. The conically tapering downstream end of the valve-closure member is pressed in its idle state by a spring force onto a valve-seat surface, which is joined downstream by a spray-discharge orifice. The spray-discharge orifice and the valve-seat surface are situated in a valve-seat member which is introduced into and welded to a nozzle body from the downstream side.

A swirl disk having recesses with a tangential component for generating a swirl in the fuel flow is situated in the fuel injector upstream from the valve-seat surface; on its way to the sealing seat, the fuel flows through these recesses. The swirl disk is pressed onto the upstream side of the valve-seat member by a spring-loaded guide disk, whereby the swirl disk is secured in its position.

German Patent Application 196 37 103 A1 describes a fuel injector where a valve needle is mechanically linked to a valve-closure member. To achieve this, the valve-closure member, having a spherical geometry, is welded to the downstream side of the valve needle. In the idle state of the fuel injector, the valve needle is acted upon in the flow direction by the spring force of a spring, and thereby presses the spherical valve-closure member onto the valve-seat surface, which is situated in a valve-seat member.

For the purpose of guiding the valve-closure member, a guide recess is introduced in the valve-seat member, the recess corresponding to the diameter of the sphere. As the fuel injector is opened, the valve needle is pulled against the flow direction and the spring force by a solenoid, so that the valve-closure member opens a flow passage for the fuel. In order for the fuel to travel from a volume upstream from the valve-closure member to the sealing seat, several ground sections, distributed over the circumference of the valve-closure member, are located on the valve-closure member. For the purpose of metering the fuel and generating a fanned-out fuel spray, a swirl disk is situated in the spray-discharge orifice downstream from the sealing seat.

In both fuel injectors mentioned above, the exiting fuel flow increases during opening, due to the increased distance between the valve-closure member and the valve-seat surface and resulting increase in the flow cross-section. The lifting valve needle opens a flow cross-section which increases with the increasing movement. The increase is nearly linear until the steady-state flow rate is reached.

A different opening behavior is known from German Patent 31 20 044 C2. The fuel injector shown there has two valve seats operating in a defined sequence. The forces necessary for opening of the valve are applied via the pressure generated by the fuel injection pump. The valve has two valve needles. In a first step, one valve needle designed as a hollow needle lifts outward from the sealing seat due to the increasing fuel pressure at the beginning of the spray-discharge operation. The rising fuel pressure results in the second valve needle guided in the hollow needle being lifted. The spray-discharged fuel amount is adjusted to the applied fuel pressure via this opening of the fuel injector in stages. The flow-through amount increases until the steady-state flow-through is reached in two consecutive steps.

The disadvantage in the described fuel injectors is the slow increase of the fuel amount spray-discharged per unit of time during the opening and closing operations. The free flow cross-section is determined by the increasing gap between the valve-closure member and the valve-seat surface during the entire opening and closing operation. The result is a very long period of time of slowly increasing fuel flow-through from the beginning of spray discharge until reaching the steady-state spray-discharge amount with a completely opened fuel injector.

The opening behavior may be positively influenced by using multi-needle valves. However, this entails a high manufacturing complexity. In order to prevent high manufacturing tolerances, the cooperation of a plurality of components requires a very precise manufacture.

### ADVANTAGES OF THE PRESENT INVENTION

The fuel injector according to the present invention having the characterizing feature of the main claim has the advantage over the related art that a very sudden increase in the flow-through occurs during the opening operation. Thereby, a larger portion of the total spray-discharged fuel is spray-discharged in a narrowly defined time window.

A gap situated between a valve needle and a valve-seat member ensures a nearly constant flow-through at the beginning of the opening operation. Therefore, the flow-through cross-section at the valve-seat surface increases during the lift movement, without a change in the amount of fuel to be spray-discharged, which is determined by a gap having a constant cross-section.

Due to the very rapid increase in the cross-section, a steep rise in the amount of fuel being spray-discharged by the fuel injector per time unit takes place. The portion of the fuel being spray-discharged via the preliminary jet is small. This makes it possible to better adjust the mixture formation with regard to ignition time and combustion time. The result is a more efficient combustion, resulting in turn in lower consumption and lower exhaust gas values.

Measures described in the dependent claims make advantageous refinements of the fuel injector according to the present invention possible.

One advantage is the large diameter of the valve needle, which, in comparison to the small radial dimension of the valve-closure member, makes the steep rise of the flow-through possible. The small radial dimension of the valve-closure member results in a great surface pressure on the sealing seat, thus ensuring a good sealing function.

A further advantage is the simple and independent adjustment of the steady-state flow-through for the completely opened fuel injector. The adjustment may take place either upstream from the gap or downstream from the gap. Swirl-generating components may also be used. The limitation of the fuel during opening of the fuel injector has no effect on the formation of a swirl.

The reduction of the preliminary jet, having little swirl, is also advantageous. The poor atomization at the beginning of the spray-discharge operation is hereby reduced. The portion of the total amount of spray-discharged fuel, spray-discharged with a good swirl, is hereby increased. This results in a finer droplet distribution and therefore in improved volatilization of the fuel, which ultimately results in improved combustion.

The advantages mentioned above for the opening operation of the fuel injector also apply in an analog manner to the closing operation of the fuel injector. The advantageous effect on harmful emissions of the engine is even greater in this case. The fuel amount supplied toward the end of the combustion cycle, which cannot be combusted optimally, is significantly reduced, thereby resulting in lesser consumption along with improved harmful emissions.

### DRAWING

Exemplary embodiments of the fuel injector according to the present invention are illustrated in the drawing in simplified form and are explained in greater detail in the following description.

FIG. 1 shows a schematic partial section through an exemplary embodiment of a fuel injector according to the present invention;

FIG. 2 shows a schematic partial section in detail II of FIG. 1 through a first exemplary embodiment of a fuel injector according to the present invention;

FIG. 3 shows a schematic partial section in detail II of FIG. 1 through a second exemplary embodiment of a fuel injector according to the present invention;

FIG. 4 shows a schematic partial section in detail II of FIG. 1 through a third exemplary embodiment of a fuel injector according to the present invention; and

FIG. 5 shows a qualitative illustration of the fuel flow-through in different fuel injectors.

### DESCRIPTION OF THE EXEMPLARY EMBODIMENTS

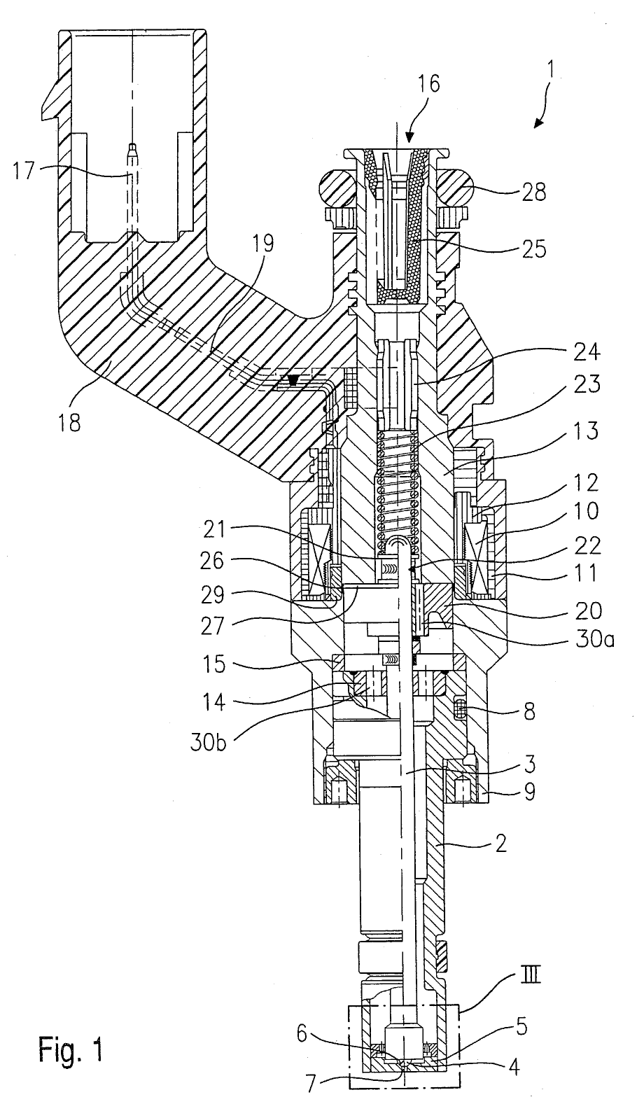

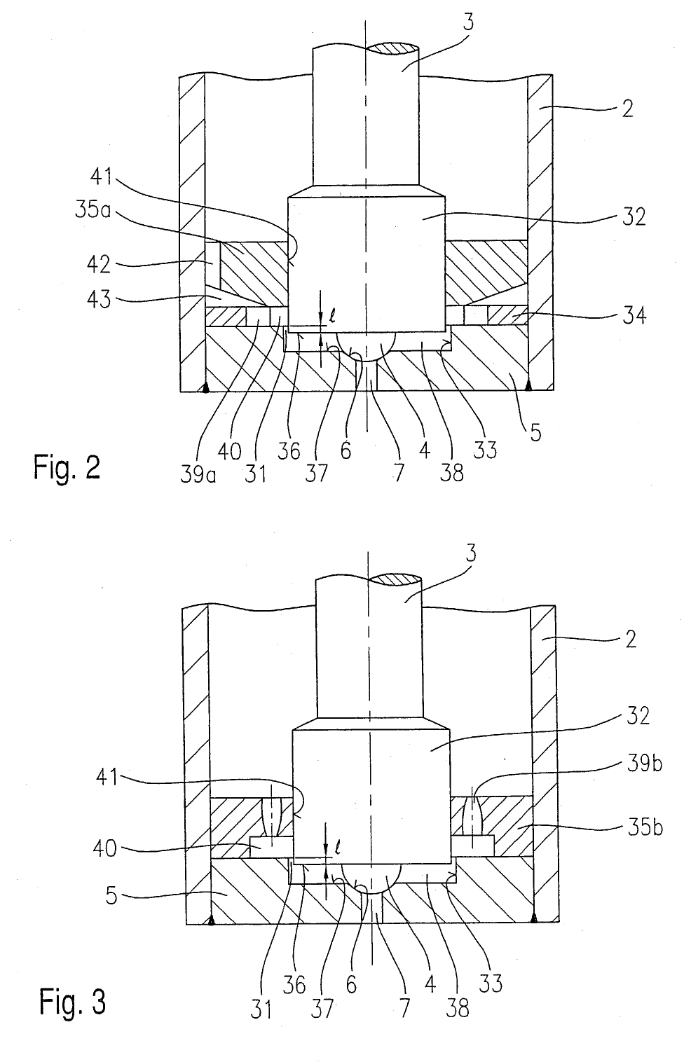

Before describing exemplary embodiments of a fuel injector 1 according to the present invention in greater detail on the basis of FIGS. 2 through 4, fuel injector 1 according to the present invention is briefly explained in an overall description with regard to its essential components, on the basis of FIG. 1, for better understanding of the present,invention.

Fuel injector 1 is configured in the form of a fuel injector 1 for fuel injection systems of mixture-compressing, spark-ignited internal combustion engines. Fuel injector 1 is particularly suitable for direct injection of fuel into a combustion chamber (not shown) of an internal combustion engine.

Fuel injector 1 includes a nozzle body 2 in which valve needle 3 is situated. Valve needle 3 is mechanically linked to a valve-closure member 4, which cooperates with a valve-seat surface 6, situated on a valve-seat member 5 to form a sealing seat. Fuel injector 1 in the exemplary embodiment is an electromagnetically actuated fuel injector 1 which has a spray-discharge orifice 7. Nozzle body 2 is sealed by gasket 8 against the external pole of solenoid 10. Solenoid 10 is encapsulated in a coil housing 11 and is wound on a field spool 12 which rests on an internal pole 13 of solenoid 10. Internal pole 13 and external pole 9 are separated from one another by a gap 26 and are supported by a connecting part 29. Solenoid 10 is energized by an electric current supplied via an electric plug-in contact 17 over a line 19. Plug-in contact 17 is enclosed by a plastic coating 18 which may be extruded onto internal pole 13.

Valve needle 3 is guided in a valve needle guide 14 which has the shape of a disk. A matching adjusting disk 15 is used for lift adjustment. An armature 20 is situated on the upstream side of adjusting disk 15. The armature is friction-locked to valve needle 3 via a first flange 21, the valve needle being connected to first flange 21 by a weld 22. In the present design of fuel injector 1 a restoring spring 23 is supported on first flange 21 and is under prestress by a sleeve 24 which is pressed into internal pole 13.

Fuel channels 30a and 30b run in valve needle guide 14 and in armature 20. A filter element 25 is situated in a central fuel supply line 16. Fuel injector 1 is sealed by a gasket 28 against a fuel supply line which is not illustrated.

In the idle state of fuel injector 1, armature 20 is acted upon by restoring spring 23 via flange 21 on valve needle 3 against its lift direction in such a way that valve-closure member 4 is held in sealing contact with valve-seat surface 6. When solenoid 10 is energized it generates a magnetic field which moves armature 20 in the lift direction against the elastic force of restoring spring 23, the lift being predetermined by a working gap 27 which in the idle position is situated between internal pole 13 and armature 20. Armature 20 entrains flange 21, which is welded to valve needle 3, thus also entraining valve needle 3 in the lift direction. Valve-closure member 4 lifts from valve-seat surface 6 and the fuel is spray-discharged from spray-discharge orifice 7.

When the coil current is turned off, armature 20 drops away from internal pole 13, after sufficient decay of the magnetic field due to the pressure of restoring spring 23 on flange 21, whereby valve needle 3 moves against the lift direction. As a result, valve-closure member 4 comes to rest on valve-seat surface 6, and fuel injector 1 is closed.

The design and function of fuel injector 1 according to the present invention are described in detail on the basis of a first exemplary embodiment, illustrated in FIG. 2. In order to achieve an improved dynamic behavior, a gap 31 is situated upstream from the sealing seat between a downstream part 32 of valve needle 3 and a recess 33. Metering of the fuel amount to be spray-discharged when fuel injector 1 is completely open is achieved by swirl disk 34, situated upstream from valve-seat member 5. A guide disk 35 used for guiding valve needle 3 is situated in nozzle body 2 upstream from swirl disk 34, and is secured by compression against axial displacement, for example.

Valve-seat member 5 has a recess 33 on its upstream side, whose radial dimension is greater than the radial dimension of downstream part 32 of valve needle 3. Valve-seat surface 6, which ends in spray-discharge orifice 7, is situated in the flow direction adjacent to recess 33. Valve-seat member 5 is preferably secured in nozzle body 2 by a sealing-weld joint.

In the idle state of fuel injector 1, valve-closure member 4 is held on valve-seat surface 6 in a sealing position. Valve-closure member 4 has a semispherical design, for example, and is situated on a downstream face 36 of valve needle 3. Downstream face 36 of valve needle 3 is preferably situated parallel to a base face 37 of recess 33. Volume 38, situated between downstream face 36 and base face 37 of recess 33, has a height in the idle state of fuel injector 1, which is determinable from the design of valve-closure member 4. The cross-section area of volume 38, through which the fuel flows radially inward, is greater than the cross-section area of gap 31.

As a function of the height of volume 38, the depth of the recess is dimensioned in a way that, in the idle state of fuel injector 1, downstream part 32 of valve needle 3 protrudes into recess 33. Due to the different radial dimensions of downstream part 32 of valve needle 3 and recess 33, gap 31 is configured to have a length 1. Length 1 of gap 31 is shorter than the distance which valve needle 3 travels when solenoid 10 is energized.

At the beginning of the opening operation, valve-closure member 4 lifts from valve-seat surface 6 and opens a flow cross-section which increases with increasing lift of valve needle 3. Preferably gap 31 is designed to be small, so that even after a short lift the cross-section area of gap 31 is smaller than the cross-section between valve-closure member 4 and valve-seat surface 6 through which fuel may flow. As valve needle 3 lifts further, length 1 of gap 31 decreases further, whereby the cross-section of gap 31 throttling the fuel flow remains constant until the downstream part 32 of valve needle 3 completely clears recess 33. The lift of valve needle 3 is dimensioned in a way that, in the end position of valve needle 3, the free flow cross-section between downstream part 32 of valve needle 3 and the upstream end of recess 33 is greater than the cross-section area which is used for metering the steady-state flow of fuel injector 1.

In the illustrated configuration, the metering of the fuel may take place, for example, via the total cross-section of swirl channels 39a, which are situated in swirl disk 34 and open into swirl chamber 40 with a tangential component. In order to guide valve needle 3, guide disk 35, whose guide recess 41 has a radial dimension corresponding to the radial dimension of valve needle 3, is situated upstream from swirl disk 34.

Guide disk 35 has supply orifices 42 which, for example, connect a circumferential channel 43 and the volume, pressurized by fuel upstream from guide disk 35, so that swirl channels 39 are supplied with fuel via circumferential channel 43.

In a second exemplary embodiment, illustrated in FIG. 3, valve-seat member 5, valve needle 3, and valve-closure member 4 correspond to the first exemplary embodiment and are not described again. However, in contrast to FIG. 2, swirl channels 39b are configured as bores in the second exemplary embodiment. They are situated in guide disk 35b, have a tangential component, and connect swirl chamber 40 with the volume pressurized by fuel upstream from guide disk 35b. Guide recess 41 is introduced in guide disk 35b.

As in the first exemplary embodiment, the cross-section area through which fuel may flow increases at the beginning of the spray-discharge operation until the cross-section area at the valve-seat surface 6 is greater than the cross-section area of gap 31. After downstream part 32 of valve needle 3 clears recess 33 and the free flow cross-section increases accordingly, the throttle point relevant for fuel metering is the sum of the cross-sections of swirl channels 39b.

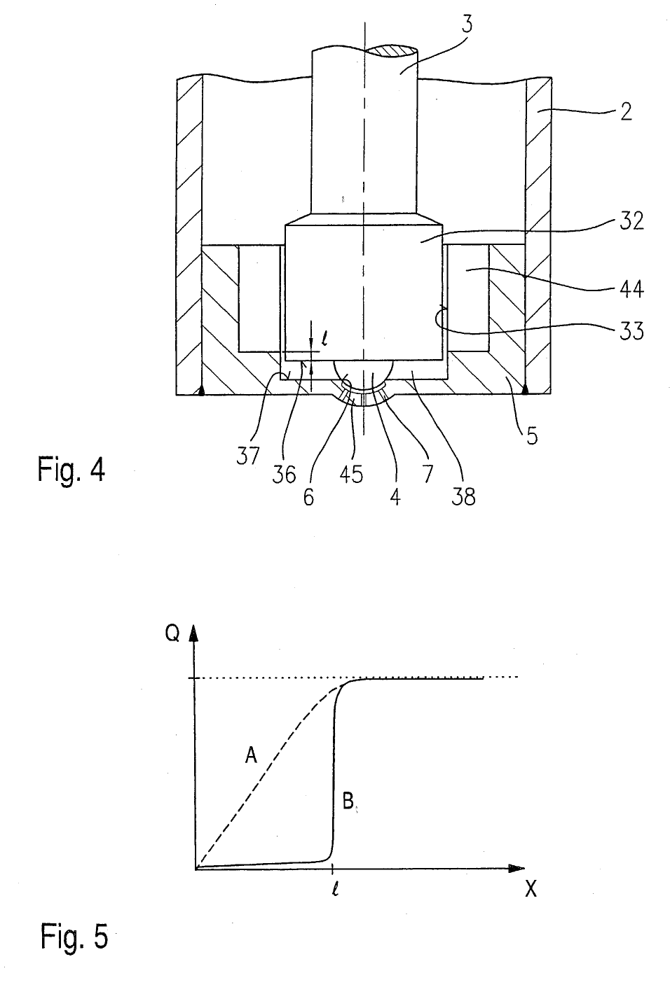

FIG. 4 shows a multi-hole valve as a third exemplary embodiment. Downstream from valve-seat surface 6 follows a dome-shaped convexity of valve-seat member 5, in which spray-discharge orifices 7 are introduced. Recess 33 is longer than necessary for forming gap 31. In order to create an effective length 1 of gap 31 feed grooves 44 are introduced in recess. 33, which, beginning at the effective length 1 of gap 31 increase the flow cross-section significantly toward the upstream side of valve-seat member 5. By actuating-fuel injector 1, downstream part 32 of valve needle 3 is moved in recess 33 against the flow direction until downstream part 32 of valve needle 3 lies completely in the area of feed grooves 44. Thus an increased cross-section is opened between the downstream end of feed grooves 44 and downstream part 32 of valve needle 3.

Metering of the steady-state flow is defined by the sum of the cross-section areas of spray-discharge orifices 7 when fuel injector 1 is completely open. The sum of the cross-sections, which is opened at the downstream end of feed grooves 44 when fuel injector 1 is completely opened, is determined by the number and the width of feed grooves 44.

The variation of the fuel flow is qualitatively plotted against the lift of valve needle 3 in FIG. 5 for a fuel injector 1 according to the related art and for a fuel injector 1 according to the present invention. The variation for a fuel injector according to the related art is illustrated by curve A and for a fuel injector 1 according to the present invention by curve B. Up to a lift length, which corresponds to length 1 of gap 31, the flow increases slightly due to a shortening of the gap length; the increase is, however, smaller than that for a fuel injector according to the related art. A steep increase takes place as the lift continues, until the flow is limited by the metering at a second throttle point.

What is claimed is:

1. A fuel injector (1) for fuel injection systems of internal combustion engines, comprising a valve-seat member (5), into which a valve-seat surface (6) is introduced, which cooperates with a valve-closure member (4), which is mechanically linked to a valve needle (3), to form a sealing seat, and comprising at least one spray-discharge orifice (7),
wherein in the idle state of the fuel injector (1) a gap (31), whose length (1) is less than the opening lift of the fuel injector (1), is situated between a downstream part (32) of the valve needle (3) and a recess (33) introduced in the valve-seat member (5) on its upstream side.

2. The fuel injector as recited in claim 1,
wherein the downstream part (32) of the valve needle (3) is designed in the shape of a cylinder.

3. The fuel injector as recited in claim 1 or 2,
wherein the recess (33) in the valve-seat member (5) is designed in the shape of a cylinder.

4. The fuel injector as recited in claim 2 and 3,
wherein the gap (31) has the shape of a hollow cylinder, i.e., it is an annular gap.

5. The fuel injector as recited in one of claims 1 through 4,
wherein the valve-closure member (4) is situated on a downstream face (36) of the valve needle (3) and its radial dimension is less than the radial dimension of the downstream part (32) of the valve needle (3).

6. The fuel injector according to one of claims 1 through 5, wherein a distance exists between a downstream face (36) of the valve needle (3) and a base face (37) of the recess (33) of the valve-seat member (5), such that the smallest cross-section area through which the fuel flows between the downstream face (36) of the valve needle (3) and the base face (37) of the recess (33) of the valve-seat member (5) is greater than the cross-section area of the gap (31).

7. The fuel injector as recited in one of claims 1 through 6,
wherein the narrowest cross-section through which the fuel flows is the sum of the cross-sections of the spray-discharge orifices (7) when the valve-closure member (4) is completely lifted.

8. The fuel injector as recited in one of claims 1 through 6,
wherein the narrowest cross-section through which the fuel flows is situated upstream from the gap (31) when the valve-closure member (4) is completely lifted.

9. The fuel injector as recited in one of claims 1 through 8,
wherein a swirl-generating element (34) is situated upstream from the gap (31).

10. The fuel injector as recited in claim 9,
wherein a swirl chamber (40) is formed in the swirl-generating element (34).

11. The fuel injector as recited in claim 10,
wherein the valve needle (3) penetrates a guide recess (41), which has a radial dimension, which corresponds to the radial dimension of the valve needle (3).
